(19) United States
(12) Patent Application Publication
(10) Pub. No.: US 2024/0267219 A1
(43) Pub. Date: Aug. 8, 2024

(54) TRUSTED COMPUTE ENVIRONMENT USING A SECURE ELEMENT AND DEVICE IDENTITY COMPOSITION ENGINE (DICE)

(71) Applicant: Micron Technology, Inc., Boise, ID (US)

(72) Inventor: Zhan Liu, Cupertino, CA (US)

(21) Appl. No.: 18/431,653

(22) Filed: Feb. 2, 2024

Related U.S. Application Data
(60) Provisional application No. 63/483,717, filed on Feb. 7, 2023.

(51) Int. Cl. H04L 9/30; H04L 9/08; H04L 9/32

(52) U.S. Cl. CPC H04L 9/30; H04L 9/088; H04L 9/3247

(57) ABSTRACT

In some aspects, the techniques described herein relate to a system including: a Device Identity Composition Engine (DICE) configured to generate asymmetric key pairs for software layers of a computing system; and a secure element (SE), the secure element configured to receive requests for accessing the software layers and validating a request for a given software layer by: generating a nonce, providing the nonce and an identifier of the given software layer to the DICE, receiving a response from the DICE, and validating the response using a public key corresponding to the given software layer to allow access to the given software layer.

### RELATED APPLICATIONS

The present application claims priority to Prov. U.S. Pat. App. Ser. No. 63/483,717 filed Feb. 7, 2023, the entire disclosure of which application is hereby incorporated herein by reference.

### FIELD OF THE TECHNOLOGY

At least some embodiments disclosed herein relate generally to the security of computing systems and, in particular, securing layers of a compute environment using a combination of a secure element (SE) and Device Identity Composition Engine (DICE).

### BACKGROUND

Computing systems are subject to various forms of attacks that compromise the security and integrity of these systems. In many systems, various components of a computing system may be viewed as sequentially executed layers. For example, a firmware layer executed first, followed by an operating system layer, followed by one or more application layers. Any of these layers may be compromised by either malicious software or software that contains errors. In current systems, a remote attestation server is used to validate such layers (e.g., by comparing a measurement of the installed layer with a golden measurement maintained by the server). Such approaches have numerous drawbacks including a failure to operate offline, additional compute resources (e.g., an additional server), and slow response times (due to network transmission delays), among others.

### BRIEF DESCRIPTION OF THE DRAWINGS

FIG. 1 is a block diagram of a secure compute environment according to some embodiments of the disclosure.

FIG. 2 is a flow diagram illustrating a method for loading DICE public keys into an SE according to some embodiments of the disclosure.

FIG. 3 is a flow diagram illustrating a method for validating access to a software layer according to some embodiments of the disclosure.

FIG. 4 is a flow diagram illustrating a method for signing a request to access a software layer according to some embodiments of the disclosure.

FIG. 5 is a block diagram illustrating a computing system according to some embodiments of the disclosure.

FIG. 6 is a block diagram of a computing device according to some embodiments of the disclosure.

### DETAILED DESCRIPTION

The example embodiments provide solutions for preventing attacks on computing systems and, in particular, to securing layers of a compute environment using a combination of an SE and DICE.

The example embodiments provide a system that includes an SE and a DICE. The SE can receive requests for accessing software layers managed by the DICE. The SE further stores public keys generated by the DICE during setup. The SE can, in response, generate a nonce and issue a challenge (e.g., request) to the DICE that include the generated nonce and a layer identifier (ID). The DICE signs the nonce and Layer ID using a private key associated with the Layer ID and returns the digital signature and, in some implementations, the nonce and Layer ID. The SE can then validate the digital signature using its stored copies of the expected public key. The SE may also validate the returned nonce and Layer ID. If all validations pass, the SE can allow access to the requested software layer. If not, the SE can deny access and take remedial measures (if implemented).

In some aspects, the techniques described herein relate to a system including: a DICE configured to generate asymmetric key pairs for software layers of a computing system; and an SE, the secure element configured to receive requests for accessing the software layers and validating a request for a given software layer by: generating a nonce, providing the nonce and an identifier of the given software layer to the DICE, receiving a response from the DICE, and validating the response using a public key corresponding to the given software layer to allow access to the given software layer.

In some aspects, the techniques described herein relate to a system, wherein the SE includes one of a trusted execution environment (TEE), Secure Enclave, or hardware security module (HSM).

In some aspects, the techniques described herein relate to a system, wherein the SE includes a write-protected storage area storing DICE public keys generated by the DICE, the DICE public keys including the public key corresponding to the given software layer.

In some aspects, the techniques described herein relate to a system, wherein the SE is configured to receive a command to store the DICE public keys from a key management server (KMS), the command signed using a private key of the KMS and verified, by the SE, using a corresponding public key of the KMS, wherein the SE is configured to read the DICE public keys from the DICE to execute the command.

In some aspects, the techniques described herein relate to a system, wherein validating the response using a public key corresponding to the given software layer includes reading the public key corresponding to the given software layer from the write-protected storage area, decrypting a digital signature included in the response to generate a decrypted result, and comparing the decrypted result to the nonce and the identifier of the given software layer to validate the response.

In some aspects, the techniques described herein relate to a system, wherein validating the response using a public key corresponding to the given software layer further includes determining if a received nonce in the response matches the nonce and if a received layer identifier matches the identifier of the given software layer prior to decrypting the digital signature.

In some aspects, the techniques described herein relate to a system, wherein the DICE is configured to receive the nonce and the identifier of the given software layer and identify a corresponding private key based on the identifier of the given software layer and generating a digital signature using the nonce and the identifier of the given software layer as a message for a digital signature algorithm.

In some aspects, the techniques described herein relate to a method including: receiving, by an SE, a request to access a software layer stored by a computing system; generating, by the SE, a nonce; transmitting, by the SE, a request to a DICE, the request including the nonce and an identifier of the software layer; receiving, by the SE, a response from the DICE; and validating, by the SE, the response using a public key corresponding to the software layer to manage access to the software layer.

In some aspects, the techniques described herein relate to a method, wherein the request to access a software layer includes a request to access a software layer managed by the DICE.

In some aspects, the techniques described herein relate to a method, wherein generating the nonce includes generating a pseudo-random value.

In some aspects, the techniques described herein relate to a method, wherein validating the response includes extracting a received nonce, a received layer identifier, and a digital signature from the response.

In some aspects, the techniques described herein relate to a method, wherein validating the response includes determining that the received nonce matches the nonce included in the request.

In some aspects, the techniques described herein relate to a method, wherein validating the response includes determining that the received layer identifier matches the identifier of the software layer included in the request.

In some aspects, the techniques described herein relate to a method, wherein validating the response includes reading the public key from a write-protected storage area, decrypting the digital signature included in the response to generate a decrypted result, and comparing the decrypted result to the nonce included in the request and the identifier of the software layer included in the request.

In some aspects, the techniques described herein relate to a method, wherein validating the response using a public key corresponding to the software layer to manage access to the software layer includes disallowing access to the software layer if: the received nonce does not match the nonce included in the request; the received layer identifier does not match the identifier of the software layer included in the request; or the decrypted result does not match the nonce included in the request and the identifier of the software layer included in the request.

In some aspects, the techniques described herein relate to a method, wherein validating the response using a public key corresponding to the software layer to manage access to the software layer includes executing the software layer by a processing device.

In some aspects, the techniques described herein relate to a method including: receiving, at a computing device, a request from an SE, the request including a nonce and a layer identifier; loading, by a computing device, a private key corresponding to the layer identifier; generating, by a computing device, a digital signature using a digital signature algorithm, the digital signature generated by using the nonce and the layer identifier as a message input into the digital signature algorithm; and returning, by a computing device, the digital signature to the SE.

In some aspects, the techniques described herein relate to a method, wherein the private key includes a private key generated by a DICE.

In some aspects, the techniques described herein relate to a method, wherein the private key is generated on startup of the computing device.

In some aspects, the techniques described herein relate to a method, further including receiving a request from the SE for public keys and returning the public keys to the SE.

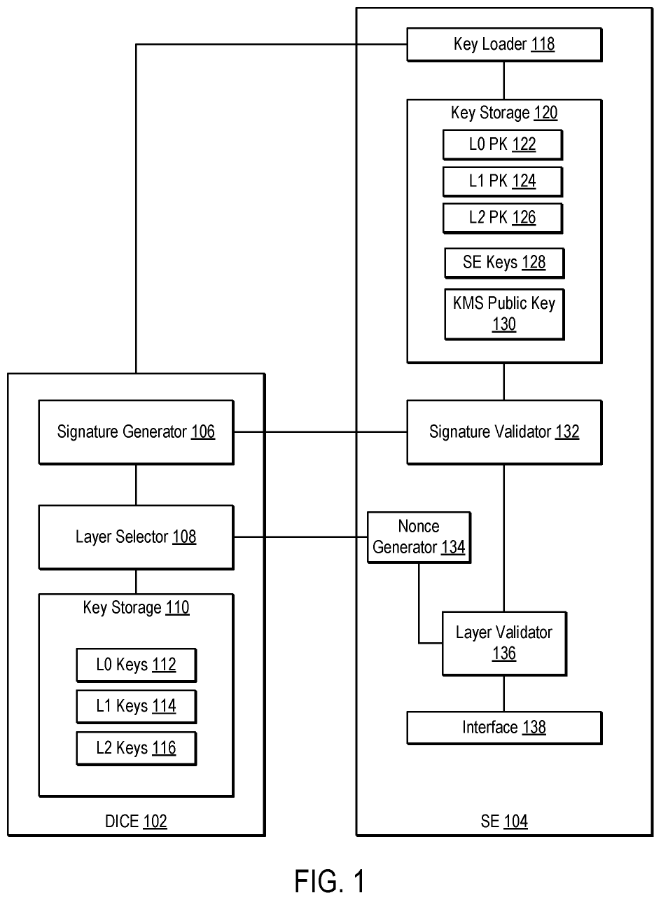

FIG. 1 is a block diagram of a secure compute environment according to some embodiments of the disclosure.

In the illustrated computing system, a DICE 102 and SE 104 are communicatively coupled. As illustrated, the DICE 102 includes a signature generator 106, layer selector 108, and key storage 110. The key storage 110 includes various keys including L0 keys 112, L1 keys 114, and L2 keys 116 (certainly more keys may be included and the specifically illustrated number is not limiting). The SE 104 includes a key loader 118, key storage 120, signature validator 132, nonce generator 134, layer validator 136, and interface 138. As illustrated, the key storage 120 may include various keys including an L0 key 122, an L1 key 124, an L2 key 126, SE keys 128, and a KMS public key 130 (certainly more keys may be included and the specifically illustrated number is not limiting). Various details of these components are described in more detail herein.

In an implementation, the DICE 102 and SE 104 may both be implemented as secure elements. Examples of a secure element include a Secure Enclave, a Hardware Security Module (HSM), a Trusted Execution Environment (TEE), a Trusted Platform Module (TPM), Secure Element in the Cloud (SEiC), or similar type of secure processing device. In some implementations, the DICE 102 and SE 104 may be the same secure element (i.e., implemented in a single TEE or other type of SE). When implemented as separate SEs, the DICE 102 and SE 104 can communicate via a secure interface (not illustrated). When implemented in the same SE, the DICE 102 and SE 104 can communicate using an internal message bus of the SE.

Both the DICE 102 and SE 104 include key storage areas (key storage 110 and key storage 120, respectively). In both devices, these areas may comprise secure storage areas within an SE. Such storage areas may not be accessible without issuing verified commands to the respective devices. For example, these storage areas may comprise write-protected storage locations within a security perimeter of the SE. Both secure storage areas store cryptographic secrets such as asymmetric keys. Asymmetric keys may comprise public and private cryptographic keys generated using an algorithm such as Rivest-Shamir-Adleman (RSA), Elliptic Curve Digital Signature Algorithm (ECDSA), Elliptic-curve Diffie-Hellman (ECDH), ElGamal, or similar algorithms. While ECDSA is generally used in the description, the disclosure is not limited to a specific asymmetric algorithm.

In key storage 110, the DICE 102 stores the various asymmetric key pairs for each layer protected by the DICE (e.g., L0 keys 112, L1 keys 114, L2 keys 116, etc.). While three layers are illustrated, there is no limit to the number of layers managed by DICE 102. Further, the DICE 102 may only protect a subset of software executed by a computing device and need not manage all software. For example, critical applications or firmware may be protected via DICE 102 while non-critical software may not. In some implementations, L0 keys 112, L1 keys 114, L2 keys 116 may comprise asymmetric key pairs (e.g., public key and private key) for each layer.

The DICE 102 may prevent access to the private key portions of these keys but may allow access to the public key portions. For example, SE 104 may utilize a key loader 118 to access the public keys and store L0 keys 112, L1 keys 114, L2 keys 116 in its own secure area (key storage 120), illustrated as L0 key 122, L1 key 124, and L2 key 126. Notably, L0 key 122, L1 key 124, and L2 key 126 comprise the public key portions of L0 keys 112, L1 keys 114, L2 keys 116.

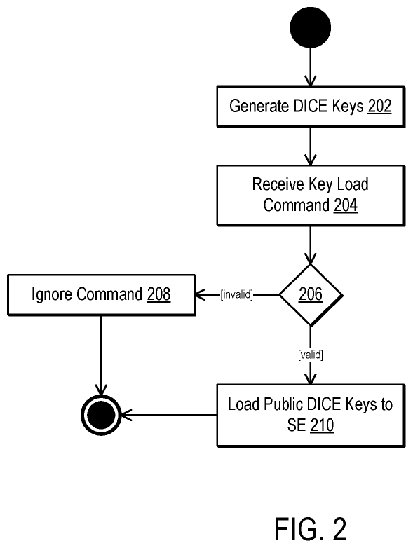

The key loader 118 may comprise firmware or software executing in SE 104 to receive a signed command (e.g., from a KMS) to load the public keys from DICE 102 into key storage 120. The key loader 118 may verify such a command by reading a KMS public key 130 and validating the command before requesting the DICE 102 provide the L0 keys 112, L1 keys 114, L2 keys 116 to the SE 104. Details of this process are described more fully in FIG. 2. In some implementations, the key storage 120 may further include the asymmetric key pair(s) of the SE 104 itself (e.g., SE keys 128) which can be used to prove the identity of SE 104 (e.g., via digital signature).

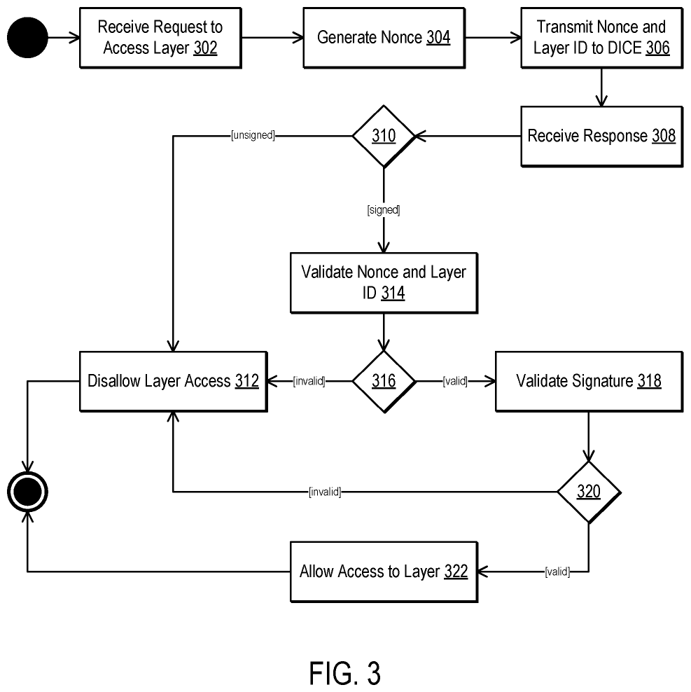

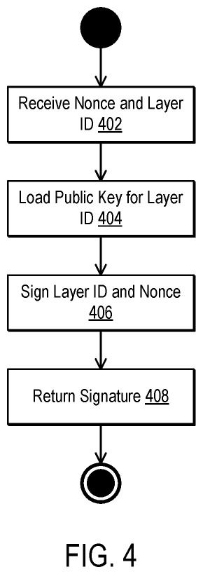

The SE 104 further includes interface 138 which can receive requests for layers from other parts of the computing system. For example, a general purpose processor may issue requests (via the OS or firmware) to load and execute software (e.g., via filenames or memory locations) corresponding to the layers of DICE 102. A layer validator 136 may receive such requests and transmit the Layer ID of the requested layer to nonce generator 134 which generates a random or pseudo-random nonce value that is transmitted (along with the Layer ID) to the DICE 102. The DICE 102 includes a layer selector 108 that receives the nonce and Layer ID and can select the corresponding public key from L0 keys 112, L1 keys 114, L2 keys 116. The signature generator 106 can generate a digital signature using the selected public key and the nonce and, in some implementations, Layer ID. The signature generator 106 can then return the digital signature (and nonce and Layer ID) to a signature validator 132 which can validate the digital signature and the nonce and Layer ID. If the signature validator 132 validates all data, the layer validator 136 can return a success message which allows access to the requested layer. Alternatively, if the signature validator 132 cannot validate all data the layer validator 136 may return an error which disallows access. In some implementations, layer validator 136, nonce generator 134 and signature validator 132 may be implemented in software or firmware instructions executed by a controller or processor of the SE 104. Similarly, signature generator 106 and layer selector 108 may also be implemented in software or firmware instructions executed by a controller or processor of the DICE 102. Functional operations of these components are described more fully in FIG. 3 (operations of SE 104) and FIG. 4 (operations of DICE 102).

FIG. 2 is a flow diagram illustrating a method for loading DICE public keys into an SE according to some embodiments of the disclosure.

In step 202, the method can include generating one or more DICE keys. In some implementations, step 202 may be implemented as part of the startup as a DICE-enabled system and the details of a standard-compliant DICE system are not repeated herein.

In brief, a DICE-enabled computing system may include various layers of functionality. In some implementations, these layers may include software layers, firmware layers, or even hardware layers that perform functions of the computing system. When such a system executes, the layers are generally executed in sequential order, although in some implementations, each layer may include multiple sub-layers. For example, a hardware circuit may comprise a DICE core root of trust that boots to a Layer 0 (L0) firmware, which boots to a Layer 1 (L1) operating system, which then executes one or more Layer 2 (L2) software applications (e.g., mail clients, web browsers, etc.). The specific nature of the software layers or their amount is not limiting.

In a DICE system, during startup each layer is associated with a set of keys. This set of keys includes at least one asymmetric key pair. An asymmetric key pair will include a public key and a private key. In a DICE system, these key pairs are generated in part on data associated with a previous layer, which ensures the integrity of the system. Details of such cascading key generation are part of the DICE standard and are not repeated herein. For purposes of the following description, it can be assumed that during startup (or at other times), such a DICE system will generate at least one asymmetric key pair for each layer measured by the DICE system.

In step 204, the method can include receiving a key load command.

In some implementations, the key load command may be received over a network from a KMS. In some implementations, the key load command may be a command having a predetermined opcode or identifier and a body. In some implementations, the key load command may be signed using a cryptographic key. In some implementations, the cryptographic key may be a private key of an asymmetric key pair. In some implementations, this asymmetric key pair can be generated and stored by the KMS.

For example, in some implementations a KMS may generate an asymmetric key pair using an algorithm such as an RSA, ECDSA, ECDH, ElGamal, or similar algorithm. The KMS may keep its private key secret and issue signed key load commands to a computing device such as that depicted in FIG. 1. In some implementations, the computing device may request the key from the KMS. In other implementations, the KMS can issue the command on its own.

In step 206, the method can include determining if the key load command is valid.

Upon receipt of the key load command, the receiving computing device can read a public key corresponding to the private key used to sign the key load command and validate that the command was signed using the expected private key. For example, an SE may store the KMS public key in a write-protected area and use this KMS public key to validate the key load command. In some implementations, step 206 can include using a digital signature verification routine provided by an asymmetric cryptography algorithm such as RSA or ECDSA. The specific details of this process are not limiting. For example, the method can include decrypting the signature and comparing the result to the key command itself (either the command or a hash thereof).

In step 208, if the signature validation fails, the method can ignore the command and halt any further processing. In this manner, only an authorized entity (e.g., the holder of the private key corresponding to the stored public key) can cause the system to transfer DICE keys.

In step 210, alternatively, if the key load command is validly signed, the method can load the DICE public keys into an SE. In some implementations, the SE may issue a command to the DICE to retrieve all public keys that are generated during the DICE process. As discussed above, this may include L0, L1, . . . LN public keys generated by the DICE. The DICE may return the public keys to the SE and the SE can store the public keys in the write-protected storage area or a similar secure location. In some implementations, the DICE may freely provide access to any public keys generated during the DICE process. In other embodiments, the SE may forward the signed key load command and the DICE, which may store the KMS public key, may additionally validate the key load command.

At the competition of the method, the SE may thus store the KMS public key, the DICE public keys, as well as its own personal asymmetric key pair. As will be described next, these DICE public keys may be used to authenticate requests to access the various software layers secured by the DICE.

FIG. 3 is a flow diagram illustrating a method for validating access to a software layer according to some embodiments of the disclosure.

In step 302, the method can include receiving a request to access a software layer. In some implementations, this access can be executing a layer, reading the contents of a layer, or generally performing any operation on the software layer. In some implementations, the request can be received by an SE from another layer or another process executing on a computing device.

In step 304, the method can include generating a nonce.

In some implementations, the nonce can comprise a random or pseudo-random value. In some implementations, the SE can use a hardware random number generator (HRNG) which may be a physical device that generates truly random numbers by measuring natural phenomena such as electronic noise. Alternatively, or in conjunction with the foregoing, the SE can use a pseudorandom number generator (PRNG). A PRNG is a software-based algorithm that generates a sequence of numbers that appears to be random but are not truly random. PRNGs are typically seeded with an initial value, such as the current time or a hardware sensor reading, to ensure that the generated numbers are unique. In some implementations, a combination of an HRNG and PRNG may be used (e.g., using the HRNG to seed a PRNG). In alternative implementations, a monotonic counter or similar mechanism may be used to generate a nonce. In some implementations, a timestamp (which is not random, but may be sufficiently unique) may be used as a nonce.

In step 306, the method can include transmitting the nonce and a Layer ID to the DICE.

In some implementations, the Layer ID may be received as part of step 302. For example, the request to access a layer may include the Layer ID. In other embodiments, the method can include identifying the Layer ID based on the requested layer. For example, a table or similar type of lookup may map filenames and/or memory addresses to layer IDs. Thus, if the request in step 302 includes a filename (e.g., application executable), the method can include looking up the Layer ID. Similarly, if the request includes a memory location (e.g., in the case of firmware), the method can look up the Layer ID for the memory address.

In step 308, after a short time, the method will receive a response from the DICE. If it does not (not illustrated), the method will terminate and branch immediately to step 312. Presuming, however, that the DICE responds, in step 308, the method will receive this response which will generally include responsive data which should include at least a digital signature. In some implementations, as well, the response may also include a received Layer ID and received nonce. In some implementations, this digital signature is generated by the DICE (described in FIG. 4) and is computed using a digital signature algorithm such as an ECDSA algorithm. Specifically, the DICE can read a private key corresponding to the Layer ID and sign a message using the private key. This message may be the concatenation (or other combination) of the nonce and Layer ID sent in step 306. Alternatively, the message may be either the nonce or Layer ID sent in step 306.

In step 310, the method can include determining if the response actually includes a signature. If not, the method immediately branches to step 312 where access to the layer requested in step 302 is disallowed. In this scenario, the method determines that the DICE is not functioning properly or is compromised in some manner as it did not generate a signature at all. In some implementations, step 312 can include returning an error to the calling device and preventing the software layer from being accessed (e.g., executed). In some implementations, step 312 can also include taking remedial measures with respect to the requested layer. For example, the computing system may include golden images of trusted software layers and step 312 may include rolling back the requested layer to the golden image (i.e., a trusted state). Alternatively, or in conjunction with the foregoing, step 312 can include logging the error or issuing an alert or notification to a computing device or user that may take action (e.g., re-installing software, etc.).

If, on the other hand, a signature is included in the response, the method proceeds to step 314 where the method validates the nonce and Layer ID. As discussed, step 314 and step 316 may be optional and only executed if one or both of a received nonce and received Layer ID are included in the response. If they are, the method will compare the received nonce and received Layer ID to the nonce generated in step 304 and the Layer ID transmitted in step 306. In this step, the method can ensure that the DICE is operating correctly and the nonce and Layer ID were not corrupted during transmission in step 306. Further, validation of the nonce prevents replay attacks for a given layer. Specifically, if only a Layer ID were signed, this signature could be cached and re-used despite the private key associated with the layer being removed. As such, if an attacker were to remove the private keys from the DICE, it could not validly sign a nonce value.

If the nonce and Layer ID (if included) are valid, the method proceeds to step 318 where it validates the digital signature included in the response. In some embodiments, step 318 can include using an ECDSA or similar type of signature algorithm to validate the signature. Then, in step 320, the results of validating the digital signature can be analyzed.

In some implementations, in step 318, the method may use a corresponding public key, which corresponds to the Layer ID and the private key used to generate the digital signature, to verify the digital signature. Using the method of FIG. 2, an SE can store an expected set of public keys that correspond the DICE layers and can store these public keys in a write-protected storage region. Thus, the DICE must sign a given layer using the correct private key and tampering can be prevented.

If the signature is determined valid in step 320, it confirms that the response is authentic and came from the DICE using the expected asymmetric key pair. As such, the method can proceed to step 322 where it will allow access to the requested layer. As described above, this may include executing, reading, or otherwise processing the underlying software, firmware, or hardware layer.

Alternatively, if the signature is not valid, it indicates that the response may have been tampered with or did not come from the intended source, and the method will terminate and branch to step 312, as discussed above.

In some implementations, the above method may be used any time a secure access to a layer is desired. In some computing systems, access to layers may either be secured (via the method) or unsecured (bypassing the method) depending on the needs of the system. As an example, an operating system (OS) may receive a request to launch an email client. The OS may issue a request to the SE (step 302) which generates a nonce (step 304) and transmits the nonce and Layer ID to the DICE (step 306). The DICE generates a response (FIG. 4) and returns a digital signature (as well as nonce and Layer ID in some implementations) to the SE (step 308). The SE then checks if the digital signature is present (step 310), validates the nonce and Layer ID (step 314), and validates the digital signature (step 318). If any of these checks fail (step 310, step 316, step 320), the SE will disallow access to the layer (step 312) by, for example, returning an error to the OS. Alternatively, if all checks pass, the SE will allow access to the layer (step 322) by, for example, returning a success message or providing the contents of the layer itself to the OS.

FIG. 4 is a flow diagram illustrating a method for signing a request to access a software layer according to some embodiments of the disclosure.

In step 402, the method can include a DICE receiving a nonce and Layer ID from an SE. In some implementations, this nonce and Layer ID can be generated by the method of FIG. 3 and transmitted to the DICE in step 306.

In step 404, the method can include loading a private key for the received Layer ID.

In some implementations, the DICE can include a write-protected or otherwise secure area of memory that stores asymmetric key pairs for each layer protected by the DICE. When receiving a Layer ID, the processor of the DICE can read this secure area and retrieve a private key that corresponds to the received Layer ID. If no such key exists, the DICE can return an error or empty response which will trigger the method of FIG. 3 to disallow layer access (step 312).

In step 406, the method can include signing the Layer ID and nonce with the private key retrieved in step 404. In some alternative implementations, only the nonce or Layer ID may be signed. In general, however, the nonce may be used in the signature to ensure freshness and prevent relay attacks. If both are used, the nonce and Layer ID may be concatenated to form a message input into a digital signature algorithm such as ECDSA.

In step 408, the method can include returning the digital signature generated using a digital signature algorithm in step 406. In some implementations, the method may only return the digital signature. In other implementations, the method may also return the data received in step 402 (e.g., the nonce and/or Layer ID). As discussed in the description of FIG. 3, this response (received in step 308) may then be verified and used to control access to the underlying layers of the DICE.

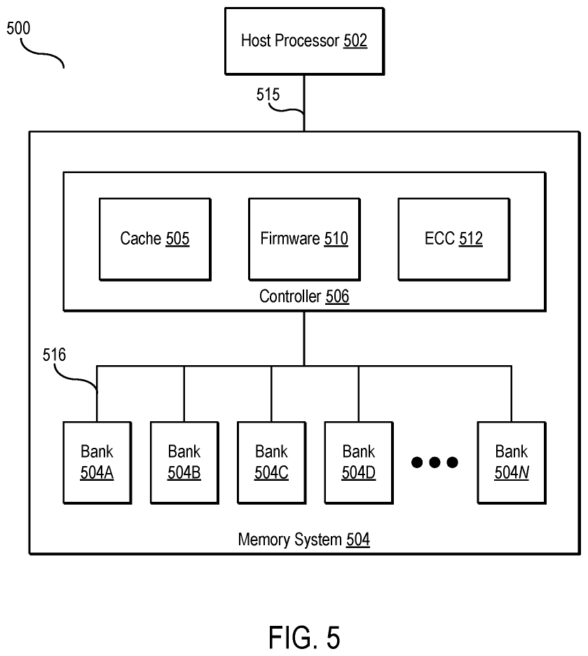

FIG. 5 is a block diagram illustrating a computing system according to some embodiments of the disclosure.

As illustrated in FIG. 5, a computing system 500 includes a host processor 520 communicatively coupled to a memory device 502 via a bus 504. The memory device 502 comprises a controller 506 communicatively coupled to one or more memory banks (e.g., banks 508A-508N, etc.) forming a memory array via an interface 512. As illustrated, the controller 506 include es a local cache 514, firmware 516, and an ECC module 518.

In the illustrated embodiment, host processor 520 can comprise any type of computer processor, such as a central processing unit (CPU), graphics processing unit (GPU), or other types of general-purpose or special-purpose computing devices. The host processor 520 includes one or more output ports that allow for the transmission of address, user, and control data between the host processor 520 and the memory device 502. In the illustrated embodiment, this communication is performed over the bus 504. In one embodiment, the bus 504 comprises an input/output (I/O) bus or a similar type of bus.

The memory device 502 is responsible for managing one or more memory banks (e.g., banks 508A-508N, etc.). In one embodiment, the memory banks (e.g., banks 508A-508N, etc.) comprise NAND Flash dies or other configurations of non-volatile memory. In one embodiment, the memory banks (e.g., banks 508A-508N, etc.) comprise a memory array.

The memory banks (e.g., banks 508A-508N, etc.) are managed by the controller 506. In some embodiments, the controller 506 comprises a computing device configured to mediate access to and from banks (e.g., banks 508A-508N, etc.). In one embodiment, the controller 506 comprises an ASIC or other circuitry installed on a printed circuit board housing the memory banks (e.g., banks 508A-508N, etc.). In some embodiments, the controller 506 may be physically separate from the memory banks (e.g., banks 508A-508N, etc.). The controller 506 communicates with the memory banks (e.g., banks 508A-508N, etc.) over the interface 512. In some embodiments, this interface 512 comprises a physically wired (e.g., traced) interface. In other embodiments, the interface 512 comprises a standard bus for communicating with memory banks (e.g., banks 508A-508N, etc.).

The controller 506 comprises various modules including local cache 514, firmware 516 and ECC module 518. In one embodiment, the various modules (e.g., local cache 514, firmware 516 and ECC module 518) comprise various physically distinct modules or circuits. In other embodiments, the modules (e.g., local cache 514, firmware 516 and ECC module 518) may completely (or partially) be implemented in software or firmware.

As illustrated, firmware 516 comprises the core of the controller and manages all operations of the controller 506. The firmware 516 may implement some or all of the methods described above. Specifically, the firmware 516 may implement the methods described in the foregoing figures.

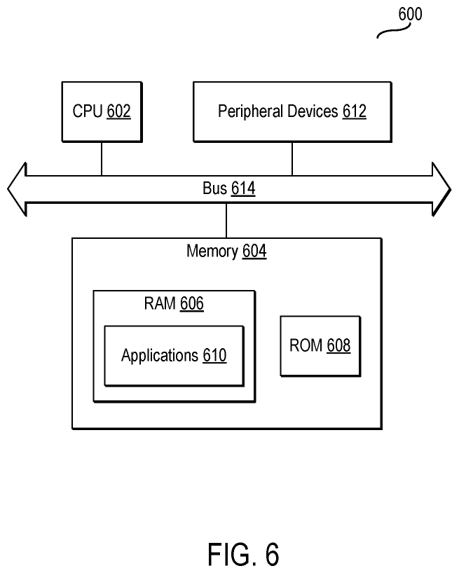

FIG. 6 is a block diagram of a computing device according to some embodiments of the disclosure.

As illustrated, the device 600 includes a processor or central processing unit (CPU) such as CPU 602 in communication with a memory 604 via a bus 614. The device also includes one or more input/output (I/O) or peripheral devices 612. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 602 may comprise a general-purpose CPU. The CPU 602 may comprise a single-core or multiple-core CPU. The CPU 602 may comprise a system-on-a-chip (SoC) or a similar embedded system. In some embodiments, a graphics processing unit (GPU) may be used in place of, or in combination with, a CPU 602. Memory 604 may comprise a memory system including a dynamic random-access memory (DRAM), static random-access memory (SRAM), Flash (e.g., NAND Flash), or combinations thereof. In one embodiment, the bus 614 may comprise a Peripheral Component Interconnect Express (PCIe) bus. In some embodiments, the bus 614 may comprise multiple busses instead of a single bus.

Memory 604 illustrates an example of a non-transitory computer storage media for the storage of information such as computer-readable instructions, data structures, program modules, or other data. Memory 604 can store a basic input/output system (BIOS) in read-only memory (ROM), such as ROM 608 for controlling the low-level operation of the device. The memory can also store an operating system in random-access memory (RAM) for controlling the operation of the device.

Applications 610 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 606 by CPU 602. CPU 602 may then read the software or data from RAM 606, process them, and store them in RAM 606 again.

The device may optionally communicate with a base station (not shown) or directly with another computing device. One or more network interfaces in peripheral devices 612 are sometimes referred to as a transceiver, transceiving device, or network interface card (NIC).

An audio interface in peripheral devices 612 produces and receives audio signals such as the sound of a human voice. For example, an audio interface may be coupled to a speaker and microphone (not shown) to enable telecommunication with others or generate an audio acknowledgment for some action. Displays in peripheral devices 612 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 612 may comprise any input device arranged to receive input from a user. An illuminator in peripheral devices 612 may provide a status indication or provide light. The device can also comprise an input/output interface in peripheral devices 612 for communication with external devices, using communication technologies, such as USB, infrared, Bluetooth®, or the like. A haptic interface in peripheral devices 612 provides tactile feedback to a user of the client device.

A GPS receiver in peripheral devices 612 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 6, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

These computer program instructions can be provided to a processor of a general purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure a computer readable medium (or computer-readable storage medium) stores computer data, which data can include computer program code or instructions that are executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A system comprising:
a Device Identity Composition Engine (DICE); and
a secure element (SE), for:
providing a nonce and an identifier of a software layer to the DICE, and
validating a response from the DICE using a public key corresponding to the software layer to allow access to the software layer.

2. The system of claim 1, wherein the SE comprises one of a trusted execution environment (TEE), Secure Enclave, or hardware security module (HSM).

3. The system of claim 1, wherein the SE includes a write-protected storage area storing DICE public keys generated by the DICE, the DICE public keys including the public key corresponding to the software layer.

4. The system of claim 3, wherein the SE is configured to receive a command to store the DICE public keys from a key management server (KMS), the command signed using a private key of the KMS and verified, by the SE, using a corresponding public key of the KMS, wherein the SE is configured to read the DICE public keys from the DICE to execute the command.

5. The system of claim 3, wherein validating the response using a public key corresponding to the software layer comprises reading the public key corresponding to the software layer from the write-protected storage area, decrypting a digital signature included in the response to generate a decrypted result, and comparing the decrypted result to the nonce and the identifier of the software layer to validate the response.

6. The system of claim 5, wherein validating the response using a public key corresponding to the software layer further comprises determining if a received nonce in the response matches the nonce and if a received layer identifier matches the identifier of the software layer prior to decrypting the digital signature.

7. The system of claim 1, wherein the DICE is configured to receive the nonce and the identifier of the software layer and identify a corresponding private key based on the identifier of the software layer and generating a digital signature using the nonce and the identifier of the software layer as a message for a digital signature algorithm.

8. A method comprising:
receiving, by a secure element (SE), a request to access a software layer stored by a computing system;
transmitting, by the SE, a request to a Device Identity Composition Engine (DICE), the request including a nonce and an identifier of the software layer; and
validating, by the SE, a response from the DICE using a public key corresponding to the software layer.

9. The method of claim 8, wherein the request to access a software layer comprises a request to access a software layer managed by the DICE.

10. The method of claim 8, wherein generating the nonce comprises generating a pseudo-random value.

11. The method of claim 8, wherein validating the response comprises extracting a received nonce, a received layer identifier, and a digital signature from the response.

12. The method of claim 11, wherein validating the response comprises determining that the received nonce matches the nonce included in the request.

13. The method of claim 12, wherein validating the response comprises determining that the received layer identifier matches the identifier of the software layer included in the request.

14. The method of claim 13, wherein validating the response comprises reading the public key from a write-protected storage area, decrypting the digital signature included in the response to generate a decrypted result, and comparing the decrypted result to the nonce included in the request and the identifier of the software layer included in the request.

15. The method of claim 14, wherein validating the response using a public key corresponding to the software layer to manage access to the software layer comprises disallowing access to the software layer if:
the received nonce does not match the nonce included in the request;
the received layer identifier does not match the identifier of the software layer included in the request; or
the decrypted result does not match the nonce included in the request and the identifier of the software layer included in the request.

16. The method of claim 14, wherein validating the response using a public key corresponding to the software layer to manage access to the software layer comprises executing the software layer by a processing device.

17. A method comprising:
receiving, at a computing device, a nonce and a layer identifier from a secure element (SE);
generating, by a computing device, a digital signature using a private key corresponding to the layer identifier and the nonce and a layer identifier as a message input; and
returning, by a computing device, the digital signature to the SE.

18. The method of claim 17, wherein the private key comprises a private key generated by a Device Identity Composition Engine (DICE).

19. The method of claim 17, wherein the private key is generated on startup of the computing device.

20. The method of claim 17, further comprising receiving a request from the SE for public keys and returning the public keys to the SE.
